(19) United States
(12) Patent Application Publication
(10) Pub. No.: US 2006/0086373 A1
(43) Pub. Date: Apr. 27, 2006

(54) Apparatus and method for drying substrates used to manufacture semiconductor devices

(76) Inventor: Sang-Oh Park, Yongin-si (KR)

Correspondence Address: HARNESS, DICKEY & PIERCE, P.L.C., P.O. BOX 8910, RESTON, VA, 20195, US

(21) Appl. No.: 11/258,012

(22) Filed: Oct. 26, 2005

(30) Foreign Application Priority Data
Oct. 27, 2004 (KR) 2004-86301

(51) Int. Cl. B08B 7/00; B08B 3/00

(52) U.S. Cl. 134/6; 134/33; 134/26; 134/137; 134/94.1; 134/95.1; 134/95.2

(57) ABSTRACT

A wafer drying apparatus may include a porous member for absorbing alcohol. The alcohol may have a higher vapor pressure than water remaining on a wafer. The porous member may migrate from the center of the wafer to the edge of the wafer. Alcohol vapor evaporated from the porous member may push the water to the outside of the wafer.

### PRIORITY STATEMENT

This US non-provisional application claims priority under 35 USC §119 from Korean Patent Application No. 2004-86301, filed on Oct. 27, 2004 in the Korean Intellectual Property Office, the disclosure of which is incorporated herein in its entirety by reference.

### BACKGROUND

1. Field of the Invention

Example embodiments of the present invention relate in general to an apparatus and a method for manufacturing semiconductor devices and, more particularly, to an apparatus and a method for drying semiconductor substrates.

2. Description of Related Art

Semiconductor devices may be manufactured by iteratively performing multiple processes such as deposition, photolithography, etching, polishing, and cleaning, for example. The cleaning process may be implemented for removing residual chemicals, small particles, contaminants remaining on a wafer surface and/or unwanted layers, for example. A cleaning process may become more significant when fine patterns are formed on a wafer.

A conventional wafer cleaning process may include a chemical treating process for etching and/or stripping contaminants from a wafer by a chemical reaction, a rinse process for rinsing chemically treated wafers using deionized water (DI water), and a dry process for drying the rinsed wafers.

A spin dryer has been used as a single-wafer dryer apparatus. The spin dryer may dry wafers using centrifugal force. A spin dryer may not completely remove waterdrops left on a wafer. Thus, watermarks may be created on the wafer after the wafer is dried.

Batch driers have also been used. A batch drier may have a treating bath offering a space in which approximately 50 wafers may be received at the same time. A batch drier may sequentially supply chemicals and DI water into the treating bath to perform a chemical treating process and a rinse process. A batch drier may also forms an isopropyl alcohol (IPA) film on a surface of the DI water to dry wafers using the Marangoni Effect, which is relatively well understood by those skilled in the art. However, if a group of wafers are dried, contaminants may remain in a treating bath. The remaining contaminants may contaminate another group of wafers dried in the treating bath. These contamination problems may become more prevalent where a chemical treating process, a rinse process, and a dry process are performed in one treating bath.

Single-wafer treating apparatuses may be used to perform the above-described cleaning process on one wafer at a time. The Marangoni Effect may be applied to a single-wafer treating apparatus. Since wafers may be vertically oriented in a batch apparatus, a flow of chemicals may be induced by gravity. Thus, a meniscus layer formed at a boundary between the DI water and a wafer surface may be maintained without shaking. On the other hand, since a flow of chemicals may be induced by centrifugal force in a single-wafer treating apparatus, a meniscus layer may be shaken (or disturbed), which may cause poor drying. If a wafer rotation speed is reduced, the disturbance of the meniscus layer may be suppressed but a process time may increase.

In the above-described apparatuses, the IPA vapor may be externally produced and supplied to the wafer by carrier gas such as nitrogen (for example). The presence of the carrier gas may reduce a concentration of the IPA vapor applied to the wafer, thereby reducing a drying efficiency. Since a nozzle configured for injecting the IPA vapor may be perpendicular to a wafer, the IPA vapor may collide with the DI water and splash the DI water to a dry end portion to create watermarks on the wafer.

With larger diameter wafers, the edge of the wafer may be naturally dried before being dried using IPA vapor. In particular, the wafer may be cleaned using hydrofluoric acid (HF), for example, and thus a surface of the wafer has hydrophobicity so that natural drying may be conducted at a local area of the wafer surface.

Generally, a wafer may be dried through first drying process and a second drying process. The first drying process may dry the wafer via the Marangoni Effect, and the second drying process may dry the wafer by heated nitrogen gases. If the first and the second drying processes are simultaneously conducted, a concentration of IPA vapor may be reduced to decrease a drying efficiency. Thus, the second drying process may occur after the first drying process of an entire area of the wafer is complete. As a result, the first and the second drying processes may consume a significant amount of time.

### SUMMARY

According to an example, non-limiting embodiment, an apparatus may include a wafer support and a vapor generator having a porous member. The porous member may be disposed over the wafer support during a drying process in which alcohol vapor may be evaporated from alcohol liquid in the porous member.

According to another example, non-limiting embodiment, an apparatus may include a rotatable wafer support supporting a wafer. A vapor generator may have a porous member for absorbing alcohol liquid. The porous member may be disposed over the wafer. A first supporting member may support the vapor generator. A moving member may be provided for moving the first supporting member so that the porous member may move from the center of the wafer to the edge of the wafer. The moving member may be coupled with the first supporting member. Alcohol vapor may be evaporated from alcohol liquid absorbed by the porous member and may be directly supplied onto the wafer. The alcohol vapor may have a higher vapor pressure than a liquid to be removed from the wafer so that the alcohol vapor pushes the liquid on a surface of the wafer.

According to another example, non-limiting embodiment, a method may involve absorbing alcohol using a porous member. The porous member may be moved from the center of a wafer to the edge of the wafer while rotating the wafer. A liquid on the wafer may be pushed toward the edge of the wafer by a pressure of alcohol vapor evaporated from the porous member.

According to another example, non-limiting embodiment, a method may involve moving a porous member having absorbed alcohol above a surface of a wafer, so that alcohol vapor evaporated from the porous member may push a liquid across the surface of the wafer.

### BRIEF DESCRIPTION OF THE DRAWINGS

Example, non-limiting embodiments of the present invention will be readily understood with reference to the following detailed description thereof provided in conjunction with the accompanying drawings, wherein like reference numerals designate like structural elements.

FIG. 1 is a cross-sectional view of a wafer drying apparatus according to an example, non-limiting embodiment of the present invention.

FIG. 2 is a perspective view of a vapor generator according to an example, non-limiting embodiment of the present invention.

FIG. 3 is a cross-sectional view taken along the line III-III of FIG. 2.

FIG. 4 is a front view of a vapor generator according to another example, non-limiting embodiment of the present invention.

FIG. 5 is a schematic illustration of alcohol vapor being supplied to a wafer from a porous member illustrated in FIGS. 1-3.

FIG. 6 is a front view of a wafer drying apparatus according to another example, non-limiting embodiment of the present invention.

FIG. 7 is a front view of a wafer drying apparatus according to another example, non-limiting embodiment of the present invention.

FIG. 8 is a schematic illustration of an alcohol vapor flow when the wafer drying apparatus of FIG. 7 is used.

FIG. 9 is a front view of a wafer drying apparatus according to another example, non-limiting embodiment of the present invention.

FIG. 10 is a front view of a wafer drying apparatus according to another example, non-limiting embodiment of the present invention.

### DETAILED DESCRIPTION OF EXAMPLE, NON-LIMITING EMBODIMENTS

Example, non-limiting embodiments of the present invention will now be described more fully with reference to the accompanying drawings. The invention may, however, be embodied in different forms and should not be construed as limited to the example embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

Well-known structures and processes are not described or illustrated in detail to avoid obscuring the present invention.

An element is considered as being mounted (or provided) “on” another element when mounted (or provided) either directly on the referenced element or mounted (or provided) on other elements overlaying the referenced element. Throughout this disclosure, terms such as “top,” “bottom,” “above,” “below,” “upwardly” and “downwardly” are used for convenience in describing various elements as shown in the figures. These terms do not, however, require that the structure be maintained in any particular orientation. Further, the terms “center” and “edge,” when used to describe portions of a wafer, simply refer to a center region and an edge region, respectively, of the wafer, and not a precise point or precise line on the wafer.

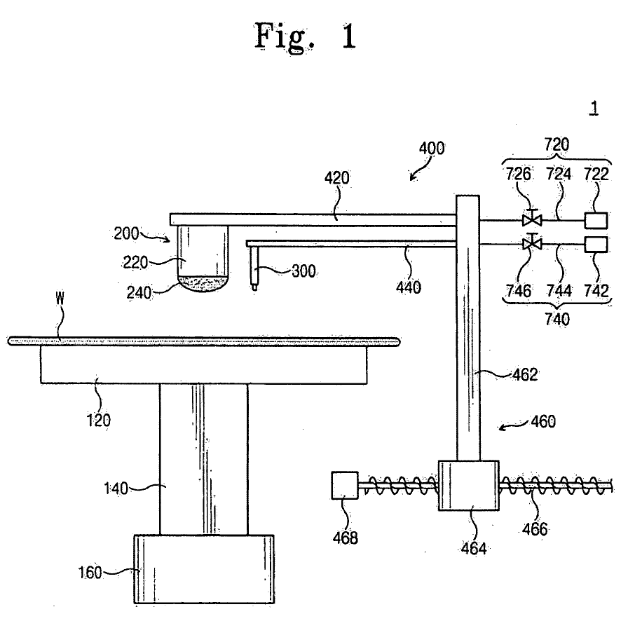

FIG. 1 illustrates a wafer drying apparatus 1 according to an example, non-limiting embodiment of the present invention. The wafer drying apparatus 1 may include a wafer support 120, a vapor generator 200, and a water supply nozzle 300. The wafer support 120 may be a disc-shaped plate and may support a wafer W during a dry process. A rotatable support shaft 140 may coupled with the bottom of the wafer support 120, so that the wafer support 120 may rotate on its axis during the dry process. The support shaft 140 may be rotated by a driver 160. The vapor generator 200 may supply alcohol vapor onto a wafer W placed on the wafer support 120 to remove water remaining on the wafer W. By way of example only, the alcohol vapor may be supplied from the center of the wafer to the edge of the wafer W. To this end, the vapor generator 200 may migrate above the upper surface of the wafer W from the center of the wafer W to the edge of the wafer W.

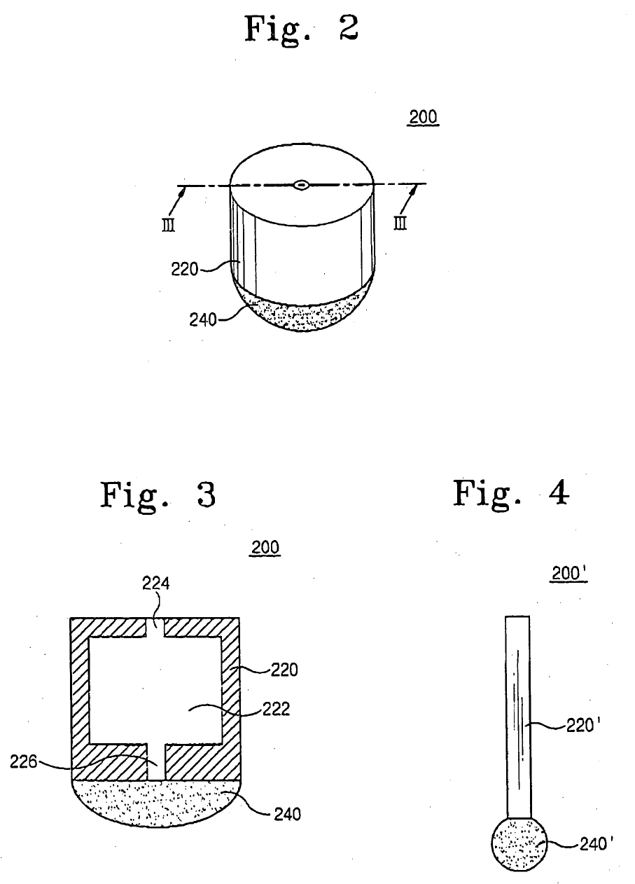

FIG. 2 is a perspective view of an example vapor generator 200, and FIG. 3 is a cross-sectional view taken along a line III-III of FIG. 2. The vapor generator 200 may have a body 220. By way of example only, the body 220 may have a cylindrical shape. The body 220 may support a porous member 240. A buffer space 222 may be formed in the body 220. The buffer space 22 of the body 220 may receive alcohol liquid from an alcohol liquid supply part 720. The body 220 may include an inflow line 224 and an outflow line 226. The inflow line 224 may extend upwardly from the buffer space 222 and penetrate a top of the body 220, and the outflow line 226 may extend downwardly from the buffer space 222 and may be connected to the porous member 240. The alcohol liquid supply part 720 may have an alcohol liquid storage element 722 (in which alcohol liquid may be stored) and an alcohol liquid supply pipe 724 that may provide a path for supplying the alcohol liquid. A valve 726 may be installed at the alcohol liquid supply pipe 724. The valve 726 may close/open the alcohol liquid supply pipe 724 and/or control a flow rate of the alcohol liquid through the alcohol liquid supply pipe 724. The valve 726 may be an electrically controllable valve such as solenoid valve, for example.

The porous member 240 may supply alcohol liquid onto the wafer W. By way of example only, the porous member 240 may have a hemispherical shape. The porous member 240 may be made of a material that readily absorbs alcohol liquid. By way of example only, the porous member 240 may be fabricated from polyvinyl alcohol. As alcohol liquid absorbed into the porous member 240 evaporates to reduce a concentration of the alcohol liquid in the porous member 240, the alcohol liquid may flow from the buffer space 222, through the outflow line 226 and into the porous member 240. This alcohol liquid flow may occur, for example, due to a concentration difference between the buffer space 222 and the porous member 240.

FIG. 4 shows another example vapor generator 200′. Here, the vapor generator 200′ may have a spherical porous member 240′ that may be supported by a rod-shaped body 220′. A path may be formed in the body 220′ for supplying alcohol liquid flowing in from an alcohol liquid supply pipe to the porous member 240′.

Returning to FIG. 1, the porous member 240 may be moved from the center of the wafer W to the edge of the wafer W by a driver 400. The driver 400 may have a first supporting member 420 and a moving member 460. The first supporting member 420 may be a rod-shaped member disposed in parallel with a top surface of the wafer W. The vapor generator 200 may be coupled with one end of the first member 420, and the moving member 460 may be coupled with the other end of the first member 420. The moving member 460 may include a rod 462 that may be disposed to be perpendicular to the first supporting member 420. The perpendicular rod 462 may be connected to a bracket 464 into which a screw 466 is inserted. The screw 466 may be rotated by a motor 468. The perpendicular rod 462 may make a straight-line motion using a rotary force of the motor 468, and the porous member 240 may make a straight-line motion from the center of the wafer W to the edge of the wafer W in a radial direction of the wafer W. In alternative embodiments, the moving member 460 may include mechanisms such as (for example) a driving mechanism including a motor, a driving pulley, a driven pulley, and a belt. Here, the perpendicular rod 462 may be connected to a motor to rotate on its axis, enabling the porous member 240 to follow a curve from the center of the wafer W to the edge of the wafer W.

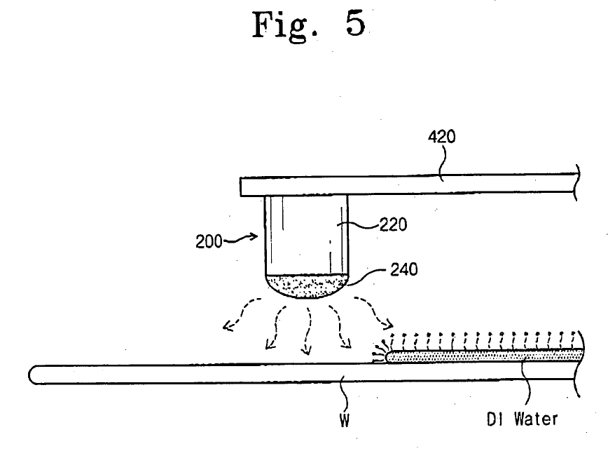

FIG. 5 illustrates alcohol vapor (schematically shown using phantom arrows) being supplied to a wafer W from the porous member 240. A vapor pressure of the alcohol liquid may be higher than that of the liquid to be removed from the wafer W. The term “vapor pressure” means the pressure of a vapor evaporated from a liquid. The easier the evaporation is, the higher the vapor pressure becomes. If the liquid to be removed from the wafer W is deionized water (DI water), alcohol such as isopropyl alcohol (IPA) and/or methanol (for example) may be used. Referring to FIG. 5, the porous member 240 may be disposed to be adjacent to the top surface of the wafer W. Alcohol vapor evaporated from alcohol liquid absorbed into the porous member 240 may be supplied onto the wafer W disposed therebelow. The evaporated alcohol vapor may be directly supplied to the wafer W without using a carrier gas. Accordingly, alcohol vapor having a higher concentration may be supplied to the wafer W, as compared to conventional techniques in which externally generated alcohol vapor may be supplied after being carried using nitrogen gas (for example). Since a vapor pressure of alcohol liquid is higher than that of DI water, alcohol vapor evaporated from the alcohol liquid may push the DI water remaining on the wafer W. As the porous member 240 moves from the center of the wafer W to the edge of the wafer W, the alcohol vapor may push the DI water to the outside of the wafer W to be removed from the wafer W. That is, the alcohol vapor (which may not be supplied/mixed with a carrier gas) may have sufficient vapor pressure to physically push the DI water along the surface of the wafer W. This physical push feature may work in conjunction with the Marangoni Effect.

A water supply nozzle 300 may supply DI water onto the wafer W. The water supply nozzle 300 may be supported by a second supporting member 440. The water supply nozzle 300 may receive DI water from a water supply part 740. The water supply part 740 may have a water storage element 742 and a water supply pipe 744 that may provide a supply passage for the DI water. A valve 746 may be installed at the water supply pipe 744. The valve 746 may open/close the water supply pipe 744 and/or control a flow rate of the DI water through the water supply pipe 744. The valve 746 may be an electrically controllable valve, for example.

The second supporting member 440 may be coupled with the perpendicular rod 462, and may be disposed below the first supporting member 420 to be parallel therewith. As the perpendicular rod 462 makes a straight-line motion (for example), the water supply nozzle 300 and the porous member 240 may move together in the same direction. By way of example only, the second supporting member 440 may be shorter than the first supporting member 420. The water supply nozzle 300 may be disposed between the perpendicular rod 462 and the porous member 240 for supplying DI water to a region of the wafer W that has not dried yet. The water supply nozzle 300 may be spaced apart from the porous member 240. If the water supply nozzle 300 is too close to the porous member 240, the DI water supplied from the water supply nozzle 300 may be splashed to a region of the wafer W that has been dried or is currently being dried. If the wafer supply nozzle 300 is too far from the porous member 240, the DI water supplied to the wafer W may be dried naturally (which may deteriorate the drying efficiency) before the wafer W is dried using the alcohol vapor. By way of example only, the distance between the water supply nozzle 300 and the porous member 240 may be 3-8 millimeters, and may be about 5 millimeters. The wafer support 120 may rotate during the drying process.

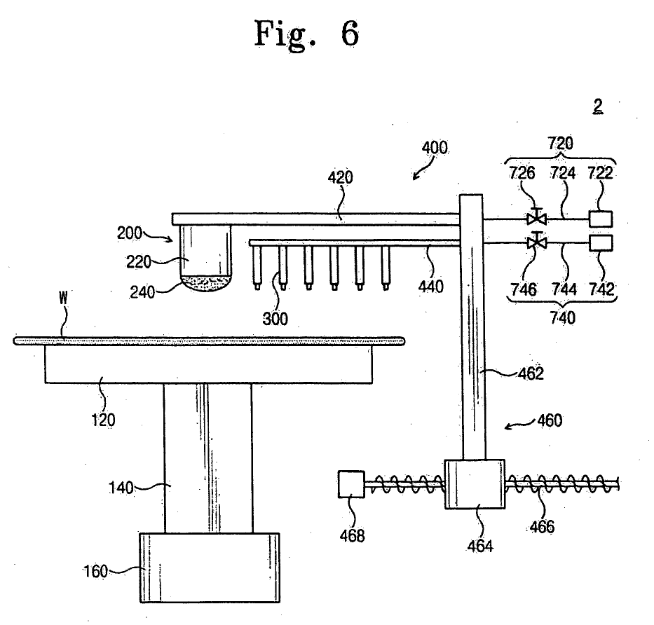

FIG. 6 is a front view of a wafer drying apparatus 2 according to another example, non-limiting embodiment of the present invention. The wafer drying apparatus 2 may include a wafer support 120, a vapor generator 200, and a plurality of water supply nozzles 300. The water supply nozzles 300 may be installed at the second supporting member 440. The water supply nozzles 300 may supply DI water from a wafer region adjacent to the porous member 240 to a wafer edge during a drying process. This may makes it possible to avoid natural drying of a region of a wafer W (particularly, the edge of the wafer W) during a drying process using alcohol vapor.

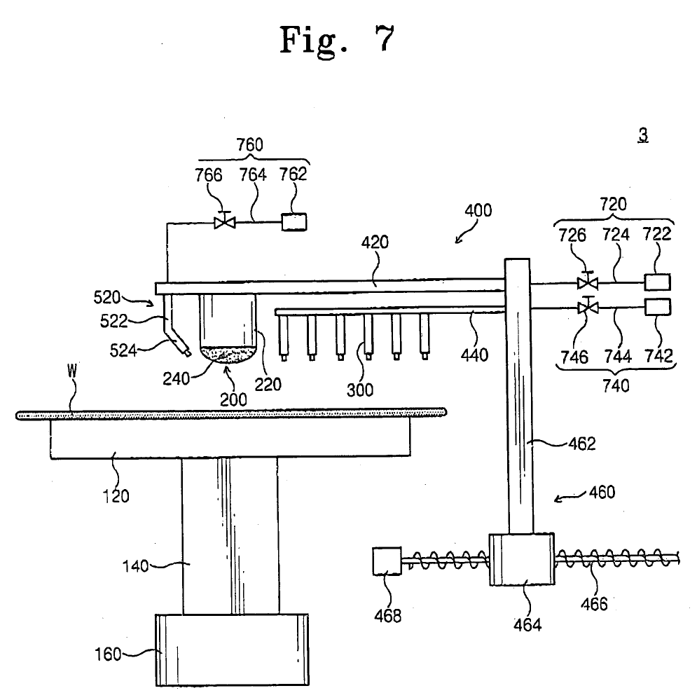

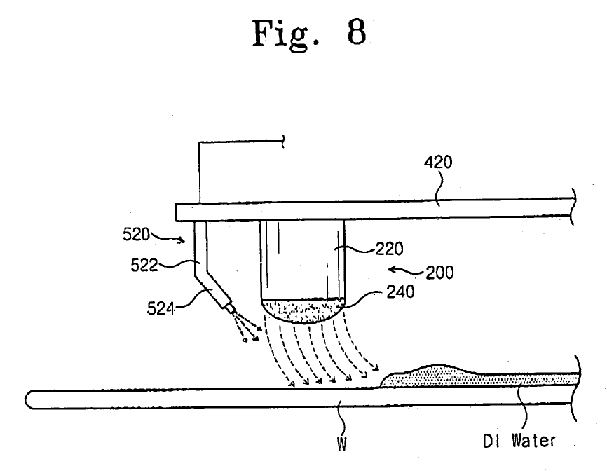

FIG. 7 is a front view of a wafer drying apparatus 3 according to another example, non-limiting embodiment of the present invention. The wafer drying apparatus 3 may include not a wafer support 120, a vapor generator 200, water supply nozzles 300 and an induced gas injection nozzle 520. As illustrated FIG. 8, the induced gas injection nozzle 520 may inject induced gas for concentrating alcohol vapor evaporated from the porous member 240 to a region of the wafer to be dried. The induced gas may be nitrogen gas and/or an inert gas, for example. An induced gas supply part 760 may have an induced gas storage element 762 and an induced gas supply pipe 764 that may provide a path for supplying induced gas to the induced gas injection nozzle 520. A valve 766 may be installed at the induced gas supply pipe 764. The valve 766 may open/close the induced gas supply pipe 764 and/or control a flow rate of induced gas through the induced gas supply pipe 764. The valve 766 may be an electrically controllable valve, for example.

The induced gas injection nozzle 520 may be provided on a downstream side of the porous member 240 relative to a moving direction of the porous member 240 during the dry process. In some cases, the induced gas injection nozzle 520 may be coupled with a terminal of the first supporting member 420. The induced gas injection nozzle 520 may have a perpendicular section 522 and an incline section 524. The perpendicular section 522 may be perpendicular to the first supporting member 420. The incline section 524 may extend toward a space between the porous member 240 and the wafer W. The induced gas injection nozzle 520 may move together with the porous member 240. As illustrated in FIG. 8, nitrogen gas injected from the induced gas injection nozzle 520 may concentrate the alcohol vapor evaporated from the porous member 240 on a region of the wafer W that is being dried. In alternative embodiments, the induced gas injection nozzle 520 may be coupled with another supporting member (instead of the first supporting member 420) and disposed to be perpendicular to a moving direction of the porous member 240.

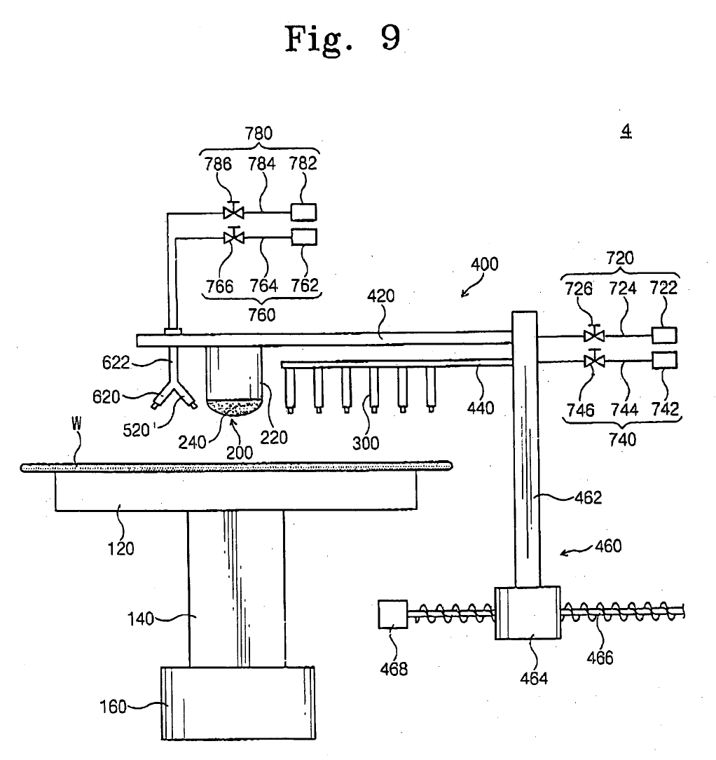

FIG. 9 is a front view of a wafer drying apparatus 4 according to another example, non-limiting embodiment of the present invention. The wafer drying apparatus 4 may include a wafer support 120, a vapor generator 200, a water supply nozzle 300, an induced gas injection nozzle 520 and a dry gas injection nozzle 620. Dry gas may be provided for removing DI water and alcohol vapor that may remain after the wafer W has been dried using the alcohol vapor. The dry gas injection nozzle 620 may receive dry gas from a dry gas supply part 780. The dry gas may be heated nitrogen gas and/or an inert gas, for example. The dry gas supply part 780 may have a dry gas storage element 782 in which dry gas may be stored and a dry gas supply pipe 784 that may provide a path for the dry gas. A valve 786 may be installed at the dry gas supply pipe 784. The valve 786 may open/close the dry gas supply pipe 784 and/or control a flow rate of dry gas through the dry gas supply pipe 784. The valve 786 may be an electrically controllable valve, for example.

In some embodiments, a gas injection nozzle may be coupled with a terminal of the first supporting member 420. The gas injection nozzle may have a perpendicular section 622 that may be perpendicular to the first supporting member 420, an induced gas injection nozzle 520′ and a dry gas injection nozzle 620. The induced gas injection nozzle 520′ may branch from the perpendicular section 622 and may be inclined and extended toward a space between the porous member 240 and the wafer W. The dry gas injection nozzle 620 may be inclined and extended in a reverse direction with respect to the induced gas injection nozzle 520′. In alternative embodiments, the dry gas injection nozzle 620 may be perpendicular to the wafer W.

Nitrogen gas may be supplied to the induced gas injection nozzle 520′ and the dry gas injection nozzle 620 through the same supply pipe. In alternative embodiments, nitrogen gas may be supplied to the induced gas injection nozzle 520′ and the dry gas injection nozzle 620 through different supply pipes so that the induced gas injection nozzle 520′ and the dry gas injection nozzle 620 may inject nitrogen gas at respective injection pressures. For example, the nitrogen gas injection nozzle 620 may inject nitrogen gas at a higher pressure than the induced gas injection nozzle 520′.

Hereinafter, wafer drying using alcohol vapor and wafer drying using dry gas will be referred to as a “first dry” and a “second dry,” respectively. In a conventional apparatus, a first dry for a wafer W may be performed by Marangoni Effect using isopropyl alcohol (IPA) vapor. If the first dry is completed for an overall region of the wafer W, a second dry may performed using heated nitrogen gas. Generally, alcohol vapor may be supplied onto the wafer W through a supply pipe by a carrier gas after being generated from an external vapor generator. If the second dry is performed during the first dry for the wafer W, nitrogen gas supplied for the second dry may flow into a region of the first dry to lower a concentration of the IPA vapor. Thus, the first dry for the wafer W may becomes inefficient. However, according to example embodiments of the present invention, alcohol vapor evaporated directly from alcohol liquid absorbed by a porous member 240 may be supplied to the wafer W. Therefore, as compared to conventional techniques, a higher concentration of the alcohol vapor may be applied to the wafer W. As a result, dry gas flowing to a region subjected to the first dry may not adversely influence the effects of the first dry.

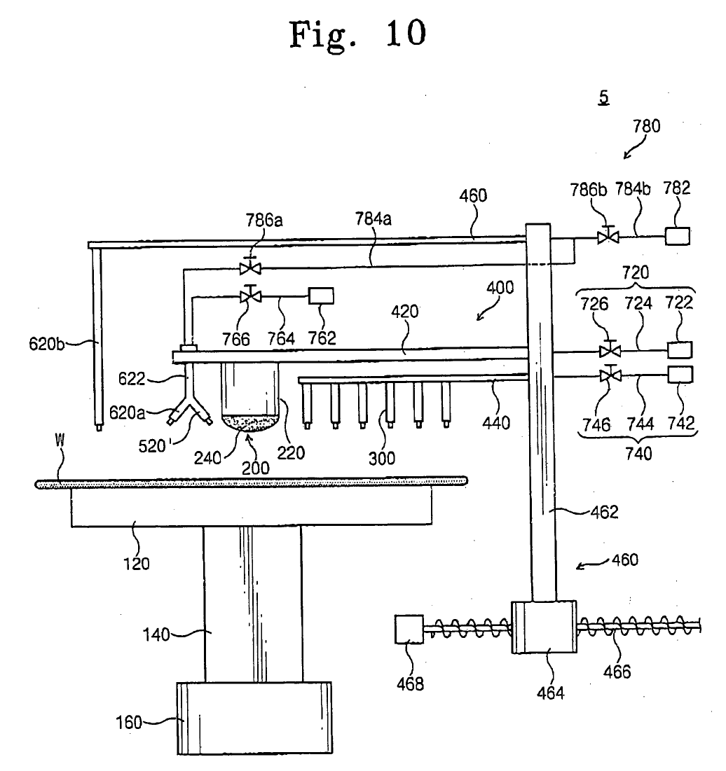

FIG. 10 is a front view of a wafer drying apparatus 5 according to another example, non-limiting embodiment of the present invention. The wafer drying apparatus 5 may include a wafer support 120, a vapor generator 200, a water supply nozzle 300, an induced gas injection nozzle 520 and a plurality of dry gas injection nozzles 620a and 620b. By way of example only, two dry gas injection nozzles 620a and 620b may be implemented. A first dry gas injection nozzle 620a may be coupled with the first supporting member 420, similar to the dry gas injection nozzle 620 described in FIG. 9. A second dry gas injection nozzle 620b may be coupled with a third supporting member 460. The third supporting member 460 may be coupled with and parallel to the first supporting member 420. The third supporting member 460 may be moveable together with the first supporting member 420. The third supporting member 460 may be longer than the first supporting member 420. The second dry gas injection nozzle 620b may extend from the third supporting member 460 and may be perpendicular to the wafer W. The second dry gas injection nozzle 620b may iteratively dry a region dried by the first dry gas injection nozzle 620a. A dry gas injection part 780 may be connected to a dry gas storage element 782 and may have a first dry gas supply pipe 784a and a second dry gas supply pipe 784b. The first dry gas supply pipe 784a may provide a path for supplying dry gas to the first dry gas injection nozzle 620a, and the second dry gas supply pipe 784b may branch from the first dry gas supply pipe 784a to provide a path for supplying dry gas to the second dry gas injection nozzle 784b. Valves 786a and 786b may be installed at the first and the second dry gas supply pipes 784a and 784b for opening/closing the same and/or for controlling dry gas flow rates, respectively.

A wafer drying method according to example embodiments of the present invention will now be described in detail. A wafer W may be placed on the wafer support 120. The first supporting member 420 may move so that a vapor generator 200 having a porous member 240 may be located at a center of the wafer W. A storage space in the body 220 of the vapor generator 200 may be filled with alcohol liquid. The alcohol liquid may be absorbed by the porous member 240. DI water may be injected from the water supply nozzles to cover an area of the wafer W adjacent to the porous member 240 to the edge of the wafer W to prevent natural drying of the wafer W. Alcohol vapor may be evaporated from the porous member 240 and supplied onto the wafer W. The alcohol vapor may physically push the DI water on the wafer W out toward the edge of the wafer W. As the porous member 240 moves from the center to the edge of the wafer W, the DI water on the wafer W may be removed therefrom. While the drying is done by the alcohol vapor, nitrogen gas and/or inert gas from an induced gas injection nozzle 520 may be injected toward a space between the porous member 240 and the wafer W. The nitrogen gas and/or inert gas may induce the alcohol vapor, evaporated from the alcohol liquid absorbed by the porous member 240, to an area of the wafer being dried. While the wafer W is dried by the alcohol vapor, heated nitrogen gas and/or inert gas may be supplied from a dry gas injection nozzle 620.

According to the example embodiments, a porous member 240, a water supply nozzle 300, an induced gas injection nozzle 520, and a dry gas injection nozzle 620 may be coupled with one supporting member and may be moved together by a driver. In alternative embodiments, the component parts may be independently moved by different drivers and/or grouped before being moved by different drivers.

The wafer drying apparatus according to example embodiments of the present invention may further include a chemical supply nozzle and/or a cleaning solution supply nozzle. The chemical supply nozzle may be provided for supplying a chemical to a wafer W, and the cleaning solution supply nozzle may be provided for supplying a cleaning solution such as DI water to a wafer W to clean the wafer W.

According to the example embodiments, alcohol liquid having a higher vapor pressure than DI water may be applied to a wafer to physically push the DI water off of the wafer W. Additionally, supplying alcohol vapor onto a wafer W may be applied to a wafer drying apparatus using Marangoni Effect.

According to example embodiments of the present invention, DI water on the wafer may be directly removed from the wafer by a pressure of vapor generated from alcohol liquid, and therefore the wafer may be dried more efficiently (as compared by conventional techniques).

Further, alcohol vapor may be evaporated from alcohol liquid and directly supplied onto the wafer. Thus, alcohol liquid having a high concentration may be supplied onto the wafer to enhance a dry efficiency.

Further, DI water may be supplied to an entire area that is not dried by alcohol vapor. Thus, DI water on a wafer is not naturally dried while alcohol vapor drying is proceeding.

Further, alcohol vapor evaporated from alcohol liquid absorbed by a porous member may be concentrated on a region of a wafer to be dried by nitrogen gas and/or inert gas supplied from an induced gas injection nozzle. Thus, a drying efficiency may be enhanced.

Further, while a first dry for a wafer may be conducted by alcohol vapor, a second dry for a wafer area where the first dry is completed may be conducted by dry gas such as heated nitrogen gas (for example) to shorten a dry process time.

While example, non-limiting embodiments of the present invention have been described in detail, it will be apparent to those skilled in the art that various changes, modifications and/or substitutions may be made therein without departing from the spirit and scope of the invention. For example, the invention may be practiced with alternative liquids and vapors (other than alcohol liquid and alcohol vapor) to remove alternative liquids (other than DI water) from the wafer.

What is claimed is:

1. An apparatus comprising:
a wafer support; and
a vapor generator having a porous member, the porous member being disposed over the wafer support during a drying process in which alcohol vapor is evaporated from alcohol liquid in the porous member.

2. The apparatus of claim 1, wherein the alcohol liquid has a higher vapor pressure than a liquid to be removed from a wafer.

3. The apparatus of claim 2, wherein the alcohol is one of isopropyl alcohol and methanol, and the liquid to be removed from the wafer is water.

4. The apparatus of claim 2, wherein the vapor generator further comprises a body in which a storage space is formed to store the alcohol liquid, the porous member being connected to an outer surface of the body,
the alcohol liquid being supplied from the storage space to the porous member by a concentration difference of the alcohol liquid in the storage space and the porous member.

5. The apparatus of claim 2, further comprising:
a driver for rotating the wafer support during a drying process; and
a driver for moving the porous member from the center of the wafer to the edge of the wafer during a drying process.

6. The apparatus of claim 5, further comprising:
a water supply nozzle assembly for injecting cleaning solution to an undried area of the wafer while the wafer is being dried by the alcohol vapor, the water supply nozzle assembly and the porous member are spaced apart from each other within a range of 3-8 millimeters.

7. The apparatus of claim 5, wherein the water supply nozzle assembly includes a plurality of water supply nozzles disposed to prevent an undried area of the wafer from being naturally dried while the wafer is being dried by the alcohol vapor.

8. The apparatus of claim 2, further comprising:
an induced gas injection nozzle for injecting one of nitrogen gas and inert gas to concentrate the alcohol vapor on a region of the wafer being dried by the alcohol vapor.

9. The apparatus of claim 2, further comprising:
a dry gas injection nozzle for injecting one of heated nitrogen gas and inert gas to a region of the wafer that has been dried by the alcohol vapor.

10. The apparatus of claim 2, wherein the porous member is fabricated from a polyvinyl alcohol.

11. An apparatus comprising:
a rotatable wafer support supporting a wafer;
a vapor generator having a porous member for absorbing alcohol liquid, the porous member being disposed over the wafer;
a first supporting member supporting the vapor generator; and
a moving member for moving the first supporting member so that the porous member moves from the center of the wafer to the edge of the wafer, the moving member being coupled with the first supporting member,
wherein, alcohol vapor evaporated from alcohol liquid absorbed by the porous member is directly supplied onto the wafer, the alcohol vapor having higher vapor pressure than a liquid to be removed from the wafer so that the alcohol vapor pushes the liquid on a surface of the wafer.

12. The apparatus of claim 11, further comprising:
water supply nozzles for injecting cleaning solution onto an undried area of the wafer while the wafer is being dried by the alcohol vapor, the water supply nozzles being arranged in a radial direction of the wafer.

13. The apparatus of claim 11, further comprising:
a second supporting member moveable in the same direction as the first supporting member, the second supporting member being coupled with the moving member; and
water supply nozzles for injecting cleaning solution onto an undried area of the wafer when the wafer is being dried by the alcohol vapor, the water supply nozzles being coupled with the second supporting member in a parallel direction with a radius of the wafer.

14. The apparatus of claim 11, further comprising:
an induced gas injection nozzle for injecting one of nitrogen gas and inert gas to concentrate the alcohol vapor on a region of the wafer being dried by the alcohol vapor.

15. The apparatus of claim 14, further comprising:
a dry gas injection nozzle for injecting one of heated nitrogen gas and inert gas to a region of a wafer that has been dried by the alcohol vapor,
wherein the induced gas injection nozzle is coupled with the first supporting member to be inclined in a moving direction of the porous member, and the dry gas injection nozzle is inclined in a reverse direction with respect to the moving direction of the porous member.

16. A method comprising:
absorbing alcohol using a porous member;
moving the porous member from the center of a wafer to the edge of the wafer while rotating the wafer; and
pushing a liquid on the wafer toward the edge of the wafer by a pressure of alcohol vapor evaporated from the porous member.

17. The method of claim 16, further comprising:
injecting cleaning solution to an undried area of the wafer while the wafer is being dried by alcohol vapor.

18. The method of claim 16, further comprising:
injecting one of nitrogen gas and inert gas to alcohol vapor evaporated from the porous member to concentrate the alcohol vapor on an area of the wafer being dried by the alcohol vapor.

19. The method of claim 16, further comprising:
injecting dry gas to a region of the wafer that has been dried by the alcohol vapor.

20. A method comprising:
moving a porous member having absorbed alcohol above a surface of a wafer, so that alcohol vapor evaporated from the porous member pushes a liquid across the surface of the wafer.

21. The method of claim 20, further comprising:
injecting cleaning solution to an undried area of the wafer while the wafer is being dried by the alcohol vapor.

22. The method of claim 20, further comprising:
injecting dry gas to a region of the wafer that has been dried by the alcohol vapor.
